(19) United States
(12) Patent Application Publication
(10) Pub. No.: US 2024/0378340 A1
(43) Pub. Date: Nov. 14, 2024

(54) METHOD, DEVICE AND STORAGE MEDIUM FOR EVALUATING WIND ENERGY RESOURCES IN COMPLEX TERRAIN

(71) Applicant: Nanjing University of Information Science & Technology, Nanjing (CN)

(72) Inventors: Miaoni Gao, Nanjing (CN); Han Jiang, Nanjing (CN); Tong Jiang, Nanjing (CN); Jinlong Huang, Nanjing (CN); Jian Zhou, Nanjing (CN); Shan Jiang, Nanjing (CN); Runhong Xu, Nanjing (CN)

(21) Appl. No.: 18/481,254

(22) Filed: Oct. 5, 2023

(30) Foreign Application Priority Data
May 12, 2023 (CN) 202310534936.1

(51) Int. Cl. G06F 30/20

(52) U.S. Cl. CPC G06F 30/20; G06F 2111/10; G06F 2113/06

(57) ABSTRACT

A method, a device and a storage medium for evaluating wind energy resources in complex terrain are provided, and the method includes: obtaining a climate field based on observation data of wind speed; obtaining an anomaly field; superimposing a climate field interpolation result and an outlier interpolation result with a consistent spatial resolution to obtain a wind speed interpolation result; performing a deviation correction on the wind speed interpolation result and the observation data of wind speed to obtain a final result; calculating an average effective wind power density; and estimating a wind power density based on a daily average wind speed. An accuracy of wind speed data is improved; the wind energy resources are evaluated in situations including complex terrain and lack of hourly wind speed data; and a high-precision data set of the wind energy resources is established to improve an evaluation accuracy of the wind energy resources.

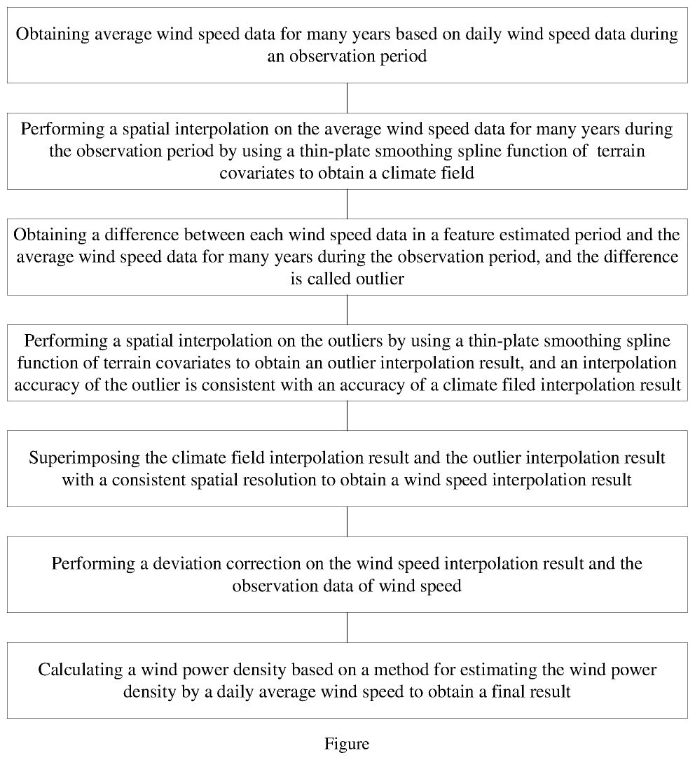

### TECHNICAL FIELD

The disclosure relates to the field of information processing technologies, and more particularly to a method for evaluating wind energy resources in complex terrain, a device for evaluating wind energy resources in complex terrain and a storage medium for evaluating wind energy resources in complex terrain.

### BACKGROUND

In recent years, due to increasingly serious environmental problems caused by a widespread use of traditional energy, people have gradually realized a necessity of using clean energy. Wind energy resources occupy a large proportion in the clean energy, and the wind energy resources have advantages of a long sustainable utilization time, a stable power generation time and a low operating cost. Wind speed and wind power density at different heights are the most important evaluation criteria of the wind energy resources, current technical difficulties include the following: a ground meteorological station is unable to achieve a full regional coverage for wind speed monitoring, hourly wind speed monitoring data with different heights and high horizontal spatial resolution is lacked, requirements for evaluating the wind energy resources cannot be satisfied, which leads to a low accuracy of current evaluation results; an effective estimation method is lacked for areas with less observation data; and a near-surface wind speed is closely related to an underlying surface, and it is difficult to evaluate the wind energy resources in complex terrain areas such as plateaus and mountains. Therefore, it is urgent to develop a wind energy resource evaluation technology suitable for a large-scale spatial range.

When evaluating the wind energy resources, there are mainly two steps. Firstly, a spatiotemporal downscaling is performed on the wind speed monitoring data, thus constructing a set of high-precision wind speed monitoring data, and the set of high-precision wind speed monitoring data is used to calculate an annual average wind speed and analyze a spatiotemporal distribution of the wind speed. Secondly, a wind power density is estimated, that is, a wind power density with a high spatiotemporal and spatial resolution is obtained based on a high-precision wind speed after the downscaling, and the wind power density with the high spatiotemporal and spatial resolution is used to analyze areas suitable for developing the wind energy resources and estimate a total amount of exploitable wind energy resources. When performing a large-scale evaluation of the wind energy resources, it is necessary to address technical challenges such as limited ground stations, lack of hourly wind speeds, and complex terrain.

### SUMMARY

A purpose of the disclosure is to provides a method, a device and a storage medium for evaluating wind energy resources in complex terrain, and the disclosure mainly solves problems of lacking calculation of high-precision wind speed data and wind energy future estimation data, lacking estimation of a wind energy density by hourly wind speed, and difficulty in evaluating high-precision wind energy resources in complex terrain.

Technique solutions of the disclosure are as follows. The disclosure provides a method for evaluating wind energy resources in complex terrain, and the method includes:
step 1, obtaining a climate field based on observation data of wind speed;
step 2, obtaining an anomaly field;
step 3, superimposing the climate field and the anomaly field with a consistent spatial resolution to obtain a wind speed interpolation result with high-precision;
step 4, performing a deviation correction on the wind speed interpolation result and the observation data of wind speed to obtain a final result;
step 5, calculating an average effective wind power density (i.e., hourly average effective wind power density); and
step 6, estimating a wind power density (i.e., daily average effective wind power density) based on a daily average wind speed.

In an exemplary embodiment, the method for evaluating wind energy resources in complex terrain further includes: estimating, based on the wind power density, a total amount of exploitable wind energy resources of a target area, determining whether the target area is suitable for developing the wind energy resources, when the target area is determined to be suitable for developing the wind energy resources, developing wind energy resources of the target area by working personnels.

In an embodiment, the step 1 includes: obtaining an average climate field based on the observation data of wind speed, and performing a spatial interpolation on the average climate field by using a thin-plate smoothing spline function of terrain covariates to obtain the climate field interpolation result; and an interpolation accuracy of the average climate field is consistent with an accuracy required for evaluating the wind energy resources.

In an embodiment, the obtaining an average climate field includes: selecting data for calculating the climate filed from an average value of wind speed observation period for thirty years.

In an embodiment, the step 2 includes: obtaining a difference between each observation data of wind speed and the climate field interpolation result as an outlier, and performing a spatial interpolation on the outlier by using a thin-plate smoothing spline function of terrain covariates to obtain an outlier interpolation result (i.e., anomaly field interpolation result); and an interpolation accuracy of the outlier is consistent with the accuracy required for evaluating the wind energy resources.

In an embodiment, in step 4, the deviation correction includes: an equidistant cumulative distribution function method; and original observation data of wind speed is processed through steps 1-3 when target-precision observation data of wind speed is lacked.

In an embodiment, the equidistant cumulative distribution function method includes formulas expressed as follows:

$$Δ = {Fuction}_{obs}^{- 1} ( {Function}_{output 2} ( variable ) ) - {Fuction}_{output 1}^{- 1} ( {Function}_{output 2} ( variable ) ) ;$$

$${variable}_{correct} = variable + Δ ;$$

where variable represents input data of a climate element variable, variable_{correct} represents a correction result of the climate element variable, Fuction represents an equidistant cumulative distribution function, Fuction⁻¹ represents an inverse operation of the equidistant cumulative distribution function, obs represents observation data of wind speed during training, output1 represents an output result during training, and output2 represents an output result during correcting.

In an embodiment, the step 5 includes:
step 5.1, estimating the wind power density based on an hourly wind speed, where a formula of the wind power density is expressed as follows:

$$WP = \frac{1}{2} {ρ}_{air} {v}^{3} ;$$

where WP represents the wind power density, v represents the hourly wind speed, and ρₐᵢᵣ represents an air density;
where a calculation formula of the air density is expressed as follows:

$${ρ}_{air} = \frac{{P}_{ave}}{{RT}_{ave}} ;$$

where Pₐᵥₑ represents annual average atmospheric pressure, R represents a gas constant, and Tₐᵥₑ represents an annual average temperature;
step 5.2, calculating an average wind power density, where a formula of the average wind power density is expressed as follows:

$$\overline{WP} = \frac{1}{2 n} {\sum }_{i = 1}^{n} {ρ}_{air} {v}_{i}^{3} ;$$

where W̅P̅ represents the average wind power density, n represents a number of records in a set period, vᵢ represents a wind speed of an i-th record of the n records, and ρₐᵢᵣ represents the air density;

step 5.3, calculating an effective wind power density, where a formula of the effective wind power density is expressed as follows:

$${WP}_{E} = \frac{1}{2} {ρ}_{air} {\int }_{{v}_{start}}^{{v}_{stop}} {Function}_{P} ( v ) \cdot vdv ;$$

where WP_{E} represents the effective wind power density, vₛₜₐᵣₜ represents a start-up wind speed, vₛₜₒₚ represents a shutdown wind speed, ρₐᵢᵣ represents the air density, and Function_{P}(v) represents a probability density function of wind speed; and
step 5.4, applying the formula of the effective wind power density to calculate the average wind power density to thereby obtain the average effective wind power density, where the applying the formula of the effective wind power density to calculate the average wind power density to thereby obtain the average effective wind power density includes:
assuming a number of records of an effective wind speed within the n records in the set period as m, where the formula f of the average wind power density is expressed as follows:

$$\overline{W P} = \frac{1}{2 n} {\sum }_{i = 1}^{n} {ρ}_{air} {v}_{i}^{3} = \frac{1}{2 n} \cdot {ρ}_{a i r} \cdot ( {v}_{1}^{3} + {v}_{2}^{3} + {v}_{3}^{3} + ⋯ + {v}_{n}^{3} ) = \frac{1}{2 n} \cdot {ρ}_{air} \cdot ( {v}_{1}^{3} + {v}_{2}^{3} + {v}_{3}^{3} + ⋯ + {v}_{m}^{3} + {v}_{m + 1}^{3} + ⋯ + {v}_{n}^{3} ) ;$$

since a wind power density that does not belong to the effective wind speed is zero in the calculation of the effective wind power density, obtaining a formula as follows:

$${v}_{m + 1}^{3} + ⋯ + {v}_{n}^{3} = 0 ;$$

where a formula of the average effective wind power density is expressed as follows:

$$\overline{W {P}_{E}} = \frac{1}{2 n} \cdot {ρ}_{air} \cdot ( {v}_{1}^{3} + {v}_{2}^{3} + {v}_{3}^{3} + ⋯ + {v}_{m}^{3} ) = \frac{1}{2 n} {\sum }_{i = 1}^{m} {ρ}_{air} {v}_{i}^{3} ;$$

where W̅P̅_̅{̅E̅}̅ represents the average effective wind power density, n represents the number of records in the set period, m represents the number of records of the effective wind speed in the set period, and ρₐᵢᵣ represents the air density.

In an embodiment, the step 6 includes:
assuming a wind speed of a i-th record being λᵢ times of an average wind speed v̅, where the formula of the average effective wind power density is expressed as follows:

$$\overline{W {P}_{E}^{′}} = \frac{1}{2 n} \cdot {ρ}_{air} \cdot [ {( {λ}_{1} \overline{v} )}^{3} + {( {λ}_{2} \overline{v} )}^{3} + {( {λ}_{3} \overline{v} )}^{3} + ⋯ + {( {λ}_{m} \overline{v} )}^{3} ] = \frac{1}{2 n} \cdot {ρ}_{air} \cdot {\overline{v}}^{3} ( {λ}_{1}^{3} + {λ}_{2}^{3} + {λ}_{3}^{3} + ⋯ + {λ}_{m}^{3} ) = \frac{1}{2 n} {ρ}_{air} {\overline{v}}^{3} {\sum }_{i = 1}^{m} ( {λ}_{i}^{3} ) ;$$

making Λ=Σᵢ₌₁^{m}(λᵢ³), where the formula of the average effective wind power density is expressed as follows:

$$\overline{W {P}_{E}^{′}} = \frac{1}{2 n} {ρ}_{air} Λ {\overline{v}}^{3} ;$$

where W̅P̅_̅{̅E̅}̅′̅ represents the average effective wind power density, n represents the number of records in a set period, v̅ represents the average wind speed, Λ represents a ratio set of the hourly wind speed and the average wind speed, a probability density function of wind speed Function_{P}(v), a shape parameter k and a scaling parameter c are calculated by a Weibull distribution, and formulas of the probability density function of wind speed Function_{P}(v), the shape parameter k and the scaling parameter c are expressed as follows:

$${Function}_{P} ( v ) = \frac{{Function}_{P} ( v )}{{Function}_{P} ( {v}_{start} \leq v \leq {v}_{stop} )} = \frac{( \frac{k}{c} ) {( \frac{v}{c} )}^{k - 1} exp [ - {( \frac{v}{c} )}^{k} ]}{exp [ - {( \frac{{v}_{start}}{c} )}^{k} ] - exp [ - {( \frac{{v}_{stop}}{c} )}^{k} ]} ;$$

$$k = {[ \frac{ave ( v )}{SLd . Deviation ( v )} ]}^{1.086} ;$$

$$c = \frac{ave ( v )}{Γ ( 1 + \frac{1}{k} )} ;$$

where Function_{P}(v) represents the probability density function of wind speed, k represents the shape parameter, c represents the scaling parameter, Std. Deviation(v) represents standard deviation of the wind speed, and Γ represents a gamma function.

The disclosure provides a device for evaluating wind energy resources in complex terrain, and the device includes a memory, a processor and a computer program stored in the memory and executed in the processor, and the computer program is configured to be executed by the processor to implement the steps of the method for evaluating wind energy resources in complex terrain.

The disclosure provides a non-transitory storage medium for evaluating wind energy resources in complex terrain, and the non-transitory storage medium stores the computer program therein, and the computer program is configured to be executed to implement the steps of the method for evaluating wind energy resources in complex terrain.

Beneficial effects of the disclosure are as follows. Compared to the related art, the disclosure has the following obvious advantages. An accuracy of wind speed data is effectively improved; a system error caused by a coarse spatial resolution is effectively reduced; a spatial distribution of the wind speed data can be effectively improved; the wind energy resources can be evaluated in complex terrain and lack of hourly wind speed data; and a high-precision data set of the wind energy resources can be established, and an evaluation accuracy of the wind energy resources can be effectively improved.

### BRIEF DESCRIPTION OF DRAWING

FIGURE illustrates a functional block diagram of a method for evaluating wind energy resources in complex terrain according to an embodiment of the disclosure.

### DETAILED DESCRIPTION OF EMBODIMENTS

Technique solutions of the disclosure will be further described in conjunction with drawings below.

An embodiment of the disclosure provides a method for evaluating wind energy resources in complex terrain, and the method includes the following steps 1-6.
In step 1, a climate field is obtained based on observation data of wind speed. Firstly, an average climate field is obtained based on the observation data of wind speed, then a spatial interpolation is performed on the average climate filed by using a thin-plate smoothing spline function of terrain covariates (i.e., adding the value of the average climate filed into the thin-plate smoothing spline function for calculation) to obtain a climate field interpolation result, and an interpolation accuracy of the average climate filed is consistent with an accuracy required for evaluating the wind energy resources. A step for obtaining the average climate field includes that data for calculating the climate field is selected from an average value of wind speed observation period for thirty years.
In step 2, an anomaly field is obtained. Firstly, a difference between each observation data of wind speed and the climate field interpolation result is obtained as an outlier, then a spatial interpolation is performed on the outlier by using a thin-plate smoothing spline function of terrain covariates (i.e., adding the outlier into the thin-plate smoothing spline function for calculation) to obtain an outlier interpolation result (i.e., anomaly field interpolation result), and an interpolation accuracy of the outlier is consistent with the accuracy required for evaluating wind energy resource.
In step 3, the climate field interpolation result (i.e., climate field) and the outlier interpolation result (i.e., anomaly field) with a consistent spatial resolution are superimposed to obtain a wind speed interpolation result.
In step 4, a deviation correction is performed on the wind speed interpolation result and the observation data of wind speed to obtain a final result; and the deviation correction includes an equidistant cumulative distribution function method; and original observation data of wind speed is processed through steps 1-3 when target-precision observation data of wind speed is lacked. Formulas of the equidistant cumulative distribution function method are expressed as follows:

$$Δ = {Function}_{obs}^{- 1} ( {Function}_{output 2} ( variable ) ) - {Function}_{output 1}^{- 1} ( {Function}_{output 2} ( variable ) ) ;$$

$${variable}_{correct} = variable + Δ ;$$

where variable represents input data of a climate element variable, variable_{correct} represents a correction result of the climate element variable, Fuction represents an equidistant cumulative distribution function, Fuction₋₁ represents an inverse operation of the equidistant cumulative distribution function, obs represents observation data of wind speed during training, output1 represents an output result during training, and output2 represents an output result during correcting.
In step 5, an average effective wind power density (i.e., hourly average effective wind power density) is calculated, and the step 5 includes the following steps 5.1-5.4.
In step 5.1, a wind power density is estimated based on an hourly wind speed, and a formula of the wind power density is expressed as follows:

$$W P = \frac{1}{2} {ρ}_{air} {v}^{3} ;$$

where WP represents the wind power density, v represents the hourly wind speed, and ρₐᵢᵣ represents an air density.

Furthermore, in step 5.1, a formula of the air density is expressed as follows:

$${ρ}_{air} = \frac{{P}_{ave}}{{RT}_{ave}} ;$$

where Pₐᵥₑ represents annual average atmospheric pressure, R represents a gas constant, and Tₐᵥₑ represents an annual average temperature;

In step 5.2, an average wind power density is calculated, and a formula of the average wind power density is expressed as follows:

$$\overline{W P} = \frac{1}{2 n} {\sum }_{i = 1}^{n} {ρ}_{air} {v}_{i}^{3} ;$$

where W̅P̅ represents the average wind power density, n represents a number of records in a set period, vᵢ represents a wind speed of an i-th record of the n records, and ρₐᵢᵣ represents the air density.

In step 5.3, an effective wind power density is calculated, and a formula of the effective wind power density is expressed as follows:

$$W {P}_{E} = \frac{1}{2} {ρ}_{air} {\int }_{{v}_{start}}^{{v}_{stop}} {Function}_{P} ( v ) \cdot vdv ;$$

where WP_{E} represents the effective wind power density, vₛₜₐᵣₜ represents a start-up wind speed, vₛₜₒₚ represents a shutdown wind speed, ρₐᵢᵣ represents the air density, and Function_{P}(v) represents a probability density function of wind speed.

In step 5.4, the formula of the effective wind power density is applied to calculate the average wind power density to thereby obtain the average effective wind power density, and a process for the applying includes the following steps.

A number of records of an effective wind speed within the n records in the set period is assumed as m, and the formula of the average wind power density is expressed as follows:

$$\overline{W P} = \frac{1}{2 n} {\sum }_{i = 1}^{n} {ρ}_{air} {v}_{i}^{3} = \frac{1}{2 n} \cdot {ρ}_{a i r} \cdot ( {v}_{1}^{3} + {v}_{2}^{3} + {v}_{3}^{3} + ⋯ + {v}_{n}^{3} ) = \frac{1}{2 n} \cdot {ρ}_{air} \cdot ( {v}_{1}^{3} + {v}_{2}^{3} + {v}_{3}^{3} + ⋯ + {v}_{m}^{3} + {v}_{m + 1}^{3} + ⋯ + {v}_{n}^{3} ) ;$$

Since a wind power density that does not belong to the effective wind speed is zero in the calculation of the effective wind power density, a formula is obtained as follows:

$${v}_{m + 1}^{3} + ⋯ + {v}_{n}^{3} = 0 .$$

Furthermore, in step 5.4, a formula of the average effective wind power density is expressed as follows:

$$\overline{W {P}_{E}} = \frac{1}{2 n} \cdot {ρ}_{air} \cdot ( {v}_{1}^{3} + {v}_{2}^{3} + {v}_{3}^{3} + ⋯ + {v}_{m}^{3} ) = \frac{1}{2 n} {\sum }_{i = 1}^{m} {ρ}_{air} {v}_{i}^{3} ;$$

where W̅P̅_̅{̅E̅}̅ represents the average effective wind power density, n represents the number of records in the set period, m represents the number of records of the effective wind speed in the set period, and ρₐᵢᵣ represents the air density.

In step 6, a wind power density (i.e., daily average effective wind power density) is estimated based on a daily average wind speed, and the step 6 includes the following steps.

A wind speed of a i-th record is assumed as λᵢ times of an average wind speed v̅ (i.e., daily average wind speed), and a formula of the average effective wind power density (i.e., daily average effective wind power density) is expressed as follows:

$$\overline{W {P}_{E}^{′}} = \frac{1}{2 n} \cdot {ρ}_{air} \cdot [ {( {λ}_{1} \overline{v} )}^{3} + {( {λ}_{2} \overline{v} )}^{3} + {( {λ}_{3} \overline{v} )}^{3} + ⋯ + {( {λ}_{m} \overline{v} )}^{3} ] = \frac{1}{2 n} \cdot {ρ}_{air} \cdot {\overline{v}}^{3} ( {λ}_{1}^{3} + {λ}_{2}^{3} + {λ}_{3}^{3} + ⋯ + {λ}_{m}^{3} ) = \frac{1}{2 n} {ρ}_{air} {\overline{v}}^{3} {\sum }_{i = 1}^{m} ( {λ}_{i}^{3} ) ;$$

When a formula Λ=Σᵢ₌₁^{m}(λᵢ³) is satisfied, the formula of the average effective wind power density is expressed as follows:

$$\overline{{WP}_{E}^{′}} = \frac{1}{2 n} {ρ}_{air} Λ {\overline{v}}^{3} ;$$

where W̅P̅_̅{̅E̅}̅′̅ represents the daily average effective wind power density, n represents the number of records in a set period, v̅ represents the average wind speed, i.e., the daily average wind speed and v̅=ave(v); Λ represents a ratio set of the hourly wind speed and the average wind speed, a probability density function of wind speed Function_{P}(v), a shape parameter k and a scaling parameter c are calculated by a Weibull distribution, and formulas of the probability density function of wind speed Function_{P}(v), the shape parameter k and the scaling parameter c are expressed as follows:

$${Function}_{P} ( v ) = \frac{{Function}_{P} ( v )}{{Function}_{P} ( {v}_{start} \leq v \leq {v}_{stop} )} = \frac{( \frac{k}{c} ) {( \frac{v}{c} )}^{k - 1} exp [ - {( \frac{v}{c} )}^{k} ]}{exp [ - {( \frac{{v}_{start}}{c} )}^{k} ] - exp [ - {( \frac{{v}_{stop}}{c} )}^{k} ]} ;$$

$$k = {[ \frac{ave ( v )}{Std . Deviation ( v )} ]}^{1.086} ;$$

$$c = \frac{ave ( v )}{Γ ( 1 + \frac{1}{k} )} ;$$

where Function_{P}(v) represents the probability density function of wind speed, k represents the shape parameter, c represents the scaling parameter, Std. Deviation(v) represents standard deviation of the wind speed, and Γ represents a gamma function.

Specifically, a calculation result of the probability density function of wind speed Function_{P}(v) is the corresponding ratio λᵢ of the hourly wind speed and the daily average wind speed. After the ratio λᵢ is obtained, Λ is obtained according to Λ=Σᵢ₌₁^{m}(λᵢ³), thus the daily average effective wind power density W̅P̅_̅{̅E̅}̅′̅ is obtained according to

$$\overline{{WP}_{E}^{′}} = \frac{1}{2 n} {ρ}_{air} Λ {\overline{v}}^{3} .$$

An embodiment of the disclosure further provides a device for evaluating wind energy resources in complex terrain, and the device includes a memory, a processor and a computer program stored in the memory and executed in the processor, and the computer program is configured to be executed by the processor to implement the steps of the method for evaluating wind energy resources in complex terrain.

An embodiment of the disclosure further provides a storage medium for evaluating wind energy resources in complex terrain, and the storage medium stores a computer program therein, and the computer program is configured to be executed to implement the steps of the method for evaluating wind energy resources in complex terrain. In some embodiments, the storage medium is a non-transitory storage medium.

1. A method for evaluating wind energy resources in complex terrain, comprising:
step 1, obtaining a climate field based on observation data of wind speed; wherein the obtaining a climate field based on observation data of wind speed comprises:
obtaining an average climate field based on the observation data of wind speed, and performing a spatial interpolation on the average climate field by using a thin-plate smoothing spline function of terrain covariates to obtain a climate field interpolation result, wherein an interpolation accuracy of the average climate field is consistent with an accuracy required for evaluating the wind energy resources;
step 2, obtaining an anomaly field; wherein the obtaining an anomaly field comprises:
obtaining a difference between each observation data of wind speed and the climate field interpolation result as an outlier, and performing a spatial interpolation on the outlier by using a thin- plate smoothing spline function of terrain covariates to obtain an outlier interpolation result, wherein an interpolation accuracy of the outlier is consistent with the accuracy required for evaluating the wind energy resources;
step 3, superimposing the climate field interpolation result and the outlier interpolation result with a consistent spatial resolution to obtain a wind speed interpolation result;
step 4, performing a deviation correction on the wind speed interpolation result and the observation data of wind speed to obtain a final result; wherein the deviation correction comprises: an equidistant cumulative distribution function method; and original observation data of wind speed is processed through steps 1-3 when target-precision observation data of wind speed is lacked;
step 5, calculating an hourly average effective wind power density;
wherein step 5 comprises:
step 5.1, estimating an hourly wind power density based on an hourly wind speed, wherein a formula of the hourly wind power density is expressed as follows:
$$WP = \frac{1}{2 n} {ρ}_{air} {v}^{3} ;$$
wherein WP represents the hourly wind power density, v represents the hourly wind speed, and ρₐᵢᵣ represents an air density;
wherein a calculation formula of the air density is expressed as follows:
$${ρ}_{air} = \frac{{P}_{ave}}{R {T}_{ave}} ;$$
wherein Pₐᵥₑ represents annual average atmospheric pressure, R represents a gas constant, and Tₐᵥₑ represents an annual average temperature;
step 5.2, calculating an hourly average wind power density, wherein a formula of the hourly average wind power density is expressed as follows:
$$\overline{WP} = \frac{1}{2 n} {\sum }_{i = 1}^{n} {ρ}_{air} {v}_{i}^{3} ;$$
wherein W̅P̅ represents the hourly average wind power density, n represents a number of records in a set period, vᵢ represents an hourly wind speed of an i-th record of the n records, and ρₐᵢᵣ represents the air density;
step 5.3, calculating an hourly effective wind power density, wherein a formula of the hourly effective wind power density is expressed as follows:
$${WP}_{E} = \frac{1}{2} {ρ}_{air} {\int }_{{v}_{start}}^{{ν}_{stop}} {Function}_{P} ( v ) \cdot vdv ;$$
wherein WP_{E} represents the hourly effective wind power density, vₛₜₐᵣₜ represents a start-up wind speed, vₛₜₒₚ represents a shutdown wind speed, ρₐᵢᵣ represents the air density, and Function_{P}(v) represents a probability density function of wind speed; and
step 5.4, applying the formula of the hourly effective wind power density to calculate the hourly average wind power density to thereby obtain the hourly average effective wind power density, wherein the applying the formula of the hourly effective wind power density to calculate the hourly average wind power density to thereby obtain the hourly average effective wind power density comprises:
assuming a number of records of an hourly effective wind speed within the n records in the set period as m, wherein the formula of the hourly average wind power density is expressed as follows:
$$\overline{WP} = \frac{1}{2 n} {\sum }_{i = 1}^{n} {ρ}_{air} {v}_{i}^{3} = \frac{1}{2 n} \cdot {ρ}_{air} \cdot ( {v}_{1}^{3} + {v}_{2}^{3} + {v}_{3}^{3} + ⋯ + {v}_{n}^{3} ) = \frac{1}{2 n} \cdot {ρ}_{air} \cdot ( {v}_{1}^{3} + {v}_{2}^{3} + {v}_{3}^{3} + ⋯ + {v}_{m}^{3} + {v}_{m + 1}^{3} + ⋯ + {v}_{n}^{3} ) ;$$
since a wind power density that does not belong to the hourly effective wind speed is zero in the calculation of the hourly effective wind power density, obtaining a formula as follows:
$${v}_{m + 1}^{3} + … + {v}_{n}^{3} = 0 ;$$
wherein a formula of the hourly average effective wind power density is expressed as follows:
$$\overline{{WP}_{E}} = \frac{1}{2 n} \cdot {ρ}_{air} \cdot ( {v}_{1}^{3} + {v}_{2}^{3} + {v}_{3}^{3} + ⋯ + {v}_{m}^{3} ) = \frac{1}{2 n} {\sum }_{i = 1}^{m} {ρ}_{air} {v}_{i}^{3} ;$$
wherein W̅P̅_̅{̅E̅}̅ represents the hourly average effective wind power density, n represents the number of records in the set period, m represents the number of records of the hourly effective wind speed in the set period, and ρₐᵢᵣ represents the air density; and
step 6, estimating a daily average effective wind power density based on a daily average wind speed;
wherein step 6 comprises:
assuming a wind speed of a i-th record being λᵢ times of the daily average wind speed v̅, wherein a formula of the daily average effective wind power density is expressed as follows:
$$\overline{{WP}_{E}^{′}} = \frac{1}{2 n} \cdot {ρ}_{air} \cdot [ {( {λ}_{1} \overline{v} )}^{3} + {( {λ}_{2} \overline{v} )}^{3} + {( {λ}_{3} \overline{v} )}^{3} + ⋯ + {( {λ}_{m} \overline{v} )}^{3} ] = \frac{1}{2 n} \cdot {ρ}_{air} \cdot {\overline{v}}^{3} ( {λ}_{1}^{3} + {λ}_{2}^{3} + {λ}_{3}^{3} + ⋯ + {λ}_{m}^{3} ) = \frac{1}{2 n} {ρ}_{air} {\overline{v}}^{3} {\sum }_{i = 1}^{m} ( {λ}_{i}^{3} ) ;$$
making
$$Λ = {\sum }_{i = 1}^{m} ( {λ}_{t}^{3} ) ,$$
wherein the formula of the daily average effective wind power density is expressed as follows:
$$\overline{{WP}_{E}^{′}} = \frac{1}{2 n} {ρ}_{air} Λ {\overline{v}}^{3} ;$$
wherein W̅P̅_̅{̅E̅}̅′̅ represents the daily average effective wind power density, n represents a number of records in a set period, v̅ represents the daily average wind speed, Λ represents a ratio set of the hourly wind speed and the daily average wind speed, the probability density function of wind speed Function_{P}(v), a shape parameter k and a scaling parameter c are calculated by a Weibull distribution, and formulas of the probability density function of wind speed Function_{P}(v), the shape parameter k and the scaling parameter c are expressed as follows:
$${Function}_{p} ( v ) = \frac{{Function}_{P} ( v )}{{Function}_{P} ( {v}_{start} \leq v \leq {v}_{stop} )} = \frac{( \frac{k}{c} ) {( \frac{v}{c} )}^{k - 1} exp [ - {( \frac{v}{c} )}^{k} ]}{exp [ - {( \frac{{v}_{start}}{c} )}^{k} ] - exp [ - {( \frac{{v}_{stop}}{c} )}^{k} ]} ;$$
$$k = {[ \frac{ave ( v )}{Std . Deviation ( v )} ]}^{1.086} ;$$
$$c = \frac{ave ( v )}{Γ ( 1 + \frac{1}{k} )} ;$$
wherein Function_{P}(v) represents the probability density function of wind speed, k represents the shape parameter, c represents the scaling parameter, Std. Deviation(v) represents standard deviation of the wind speed, and Γ represents a gamma function; and
wherein the method for evaluating wind energy resources in complex terrain further comprises: estimating, based on the daily average effective wind power density, a total amount of exploitable wind energy resources of a target area, determining whether the target area is suitable for developing the wind energy resources, when the target area is determined to be suitable for developing the wind energy resources, developing wind energy resources of the target area by working personnel.

2. The method as claimed in claim 1, wherein the calculating an average climate field comprises: selecting data for calculating the climate filed from an average value of wind speed observation period for thirty years.

3. The method as claimed in claim 1, wherein the equidistant cumulative distribution function method comprises formulas expressed as follows:
$$Δ = {Function}_{obs}^{- 1} ( {Function}_{output 2} ( variable ) ) - {Function}_{output 1}^{- 1} ( {Function}_{output 2} ( variable ) ) ;$$
$${variable}_{correct} = variable + Δ ;$$
wherein variable represents input data of a climate element variable, variable_{correct} represents a correction result of the climate element variable, Fuction represents an equidistant cumulative distribution function, Fuction⁻¹ represents an inverse operation of the equidistant cumulative distribution function, obs represents observation data of wind speed during training, output1 represents an output result during training, and output2 represents an output result during correcting.

4-5. (canceled)

6. A device for evaluating wind energy resources in complex terrain, comprising a memory, a processor and a computer program stored in the memory and executed in the processor, wherein the computer program is configured to be executed by the processor to implement the steps of the method as claimed in claim 1.

7. (canceled)
